(19) United States
(12) Patent Application Publication
(10) Pub. No.: US 2026/0369067 A1
(43) Pub. Date: Nov. 19, 2026

(54) YARD CONTAINER AND ASSET TRACKING SYSTEM

(71) Applicant: KoiReader Technologies, Inc., Dallas, TX (US)

(72) Inventors: Ashutosh Prasad, Dallas, TX (US); Vivek Prasad, Bengaluru (IN)

(21) Appl. No.: 19/139,984

(22) PCT Filed: Dec. 22, 2023
(86) PCT No.: PCT/US2023/085621

§ 371 Date: Jun. 17, 2025

Related U.S. Application Data
(60) Provisional application No. 63/478,249, filed on Jan. 3, 2023.

(51) Int. Cl. G06V 20/54; G01C 21/00; G06Q 10/087; G06V 10/14

(52) U.S. Cl. CPC G06V 20/54; G01C 21/3841; G06Q 10/087; G06V 10/14; G06V 2201/08

(57) ABSTRACT

A system for generating a visual asset map of a yard or facility in substantially real-time. The visual asset map may be generated on-the-fly based on various vehicles and containers entering and exiting the yard or facility. In some cases, the visual asset map may be generated both horizontally along the ground and vertically, such as to accommodate stacking of containers. The visual asset map may be utilized to track asset identifiers together with associated inventory through the yard or facility.

### CROSS-REFERENCE TO RELATED APPLICATIONS

This application is a U.S. national stage application under 35 USC § 371 of International Application No. PCT/US23/85621 filed on Dec. 22, 2023, and entitled “YARD CONTAINER AND ASSET TRACKING SYSTEM,” which claims priority to claims priority to U.S. Provisional Application No. 63/478,249 filed on Jan. 3, 2023 and entitled “YARD CONTAINER AND ASSET TRACKING SYSTEM,” the entire contents of which are incorporated herein by reference.

### BACKGROUND

Storage facilities, such as yards, distribution centers, ports, and the like, receive, process, store, and output vast quantities of assets and containers over time. In some cases, assets may become lost or misplaced within the yard. Conventional systems may utilize per container or asset tags which must be installed upon receipt of the container or asset and removed prior to output. However, affixing and removing asset tags is costly and time consuming.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of an image device and an asset tracking system 104 for mapping yards and tracking and recording asset and container locations within the yard grounds, according to some implementations.

FIG. 2 is a flow diagram illustrating an example process associated with the asset tracking system of FIG. 1, according to some implementations.

FIG. 3 is another flow diagram illustrating an example process associated with the asset tracking system of FIG. 1, according to some implementations.

FIG. 4 is another flow diagram illustrating an example process associated with the asset tracking system of FIG. 1, according to some implementations.

FIG. 5 is another flow diagram illustrating an example process associated with the asset tracking system of FIG. 1, according to some implementations.

FIG. 6 is an example asset tracking system that may implement the techniques described herein according to some implementations.

FIG. 7 is an example image device that may implement the techniques described herein according to some implementations.

FIG. 8 is an example pictorial diagram that shows a yard with multiple containers that may be scanned to determine regions and identification data as described herein according to some implementations.

FIG. 9 is an example pictorial diagram that shows a vehicle being identified as the vehicle enters a yard according to some implementations.

### DETAILED DESCRIPTION

Discussed herein are systems and devices for automating the tracking positions of containers and assets as well as scheduling of events (such as delivery, loading, unloading, and storing of assets at a facility and/or yard). In some examples, an asset tracking system or platform may be configured to utilize one or more image devices (such as cameras, video devices, pan-tilt-zoom devices, 360-degree scanning systems, lidar system, and the like) to determine an identity and track a location of assets and/or containers as the assets and containers enter, exit, and are otherwise moved through the yard. For instance, the system may be configured to track assets and containers that are stored at the facility (e.g., at a preparation area, holding area, storage area, on the vehicles parked at the yard, and the like).

In some cases, the asset tracking system may also track assets and containers as the assets and containers are moved about the yard, loaded and/or unloaded from one or more vehicles, and the like. For instance, the asset tracking system may receive sensor data associated with assets and/or containers as the assets and/or containers enter the yard, are delivered to designated storage locations, and/or exit the yard. For example, the sensor data may be received from one or more pan-tilt-zoom (PTZ) image devices positioned within the yard. For instance, one image device may be utilized for each delivery vehicle that may enter the yard at a given time (e.g., if three vehicles are able to load and unload at a time, the system may utilize three image devices). In other cases, the system may utilize one additional image device than the number of delivery vehicles that may enter the yard at a given time. In some examples, the image devices may be fixed, such as along the edge of the yard, on towers within the yard grounds, associated with the yard equipment, operators, and/or vehicles (such as mounted on forklifts and/or attached to facility operator's vests or helmets, and the like).

In some cases, the PTZ image device may be configured to perform predetermined scans of the yard or physical environment. For example, the PTZ image device may rotate or spin such that the PTZ image device is able to zoom in and capture detailed image data associated with each defined region of the yard once per scan or period of time (such as once every minute, once every half a minute, or the like). In other cases, the PTZ image device may be configured to detect delivery vehicles, loading/unloading events, and the like and track the vehicle and/or event as the assets are loaded, unloaded, or otherwise moved within the yard. In the case of multiple PTZ image devices, each device may be assigned to track a different event or vehicle and/or to track events and/or vehicles within predefined field of views. For example, a delivery vehicle moving through a yard may be first tracked by a first PTZ image device within a first field of view associated with the first PTZ image device and then transitioned to be tracked by a second PTZ image device when the vehicle enters a second field of view associated with the second PTZ image device. In another example, the first PTZ image device may track a first vehicle within the yard and the second PTZ image device may track a second vehicle within the yard. In one specific example, the asset tracking system may implement a first set of PTZ image devices where each PTZ image device of the set tracks individual vehicles and a second set of PTZ image devices that scan the yard, as discussed above.

In some examples, the asset tracking system may generate a virtual map, grid, or other type of location mapping associated with the yard. The virtual map may be portioned into one or more regions and each region may be associated with a storage location for assets, containers, trailers, and/or parked vehicles. In some cases, the virtual map may generate a historical record of the flow of assets and/or containers into and out of the yard. The historical record or data may then be used to assist in scheduling of departures and/or arrivals of additional assets, such as via, one or more machine learned models. In some cases, the virtual map may be formed as a pixel map of the yard with designated or defined positions or regions (such as defined when the yard is empty). In this manner, the system may determine the position, region, or location of a vehicle or container within the yard based at least in part on the pixel map.

The virtual map may also be used to generate a delivery schedule or estimated wait time for drivers (or other delivery personal) arriving at the facility with a delivery as well as a pickup schedule or estimated wait time for drivers waiting on assets to deliver to another location. In some cases, the asset tracking system may include a display located at a waiting area or entry area of the yard indicating scheduling data, such as wait time and availability of empty yard regions. In other cases, the schedule data may be provided to a user device, such as a smart phone, via, for example, a web-interface, cloud-based service interface, downloadable application, or the like.

As an example, the system may utilize one or more occupancy metrics (e.g., fullness, total capacity, variable capacity, and the like) together with individual region metrics (e.g., available size, vertical stacking capacity, accessibility, and the like) as well as the delivery schedule (e.g., incoming asset schedule, estimated time to arrival, shipment size, and the like), the shipping schedule (exiting asset schedule, estimated time to arrival, shipment size, and the like), asset characteristics (e.g., size, weight, dimensions, demand, estimated storage times, and the like) to determine or update the delivery schedule for one or more incoming or outgoing shipments. For instance, the system may re-route vehicles to other facilities if the capacity metric exceeds one or more thresholds, if the incoming assets fail to fit in any available region space. In some cases, the system may schedule facility events (e.g., moving assets, rearranging assets, breaking down assets, shelving assets, unloading/loading of assets, packaging of assets, processing assets, and the like) to adjust the current position of stored or existing assets within the facility to accommodate incoming shipments or reduce processing time with outgoing shipments. In this manner, the system may maintain a real-time on-the-fly schedule for incoming and outgoing shipments.

In some cases, the virtual map may be three-dimensional to allow for both horizontal regions (such as parking slots for delivery vehicles and/or trailers) as well as vertical regions (such as for stackable containers or the like, typically used in ports and the like). In these cases, the virtual map may include a top-down or birds-eye view of the facility including occupied regions, unoccupied regions, facility personnel and equipment locations, image device locations, delivery vehicle's locations, and the like (such as in pictorial representations or icons having varying colors or patterns to easily distinguish from each other). The virtual map may be able to transition to and forth to a three-dimensional model. In the three-dimensional model, the virtual map may be interactive, such as rotatable, zoomable, sizable, and the like. In some cases, by selecting a pictorial representation within the two-dimensional or three-dimensional map, the virtual map may cause additional information about the region, personnel, equipment, vehicle, container, and/or assets to be displayed.

In some cases, a facility operator may utilize the three-dimensional virtual map to assign tasks to equipment (such as autonomous equipment), personnel (e.g., loading crew, unloading crew, forklift or vehicle operators, and the like), and/or schedule arrivals and departures (such as with incoming and outgoing delivery vehicles). In some examples, the virtual map may also include asset and/or container data, such as number, units, and/or type of assets, asset characteristic (e.g., dimensions, sizes, weight, and the like), asset identifiers, task-based and/or event-based data (such as estimated loading/unloading time), estimated personnel or equipment per task or event, asset, container, trailer, or vehicle data (such as identifiers, licenses, and the like), and the like.

In one specific example, the asset tracking system may also receive delivery data from the delivery vehicles, such as estimated arrival times, other delivery locations (such as when multiple stops or facilities are associated with a single delivery job or the like), location data, identifying data, and the like. The asset tracking system may combine the delivery data with the asset data or the virtual map data to provide scheduling adjustments for individual delivery vehicles. For example, the asset tracking system may adjust an order of the deliveries at one or more locations or facilities, such that the delivery vehicle may arrive at a time when the yard has at least one open region for receiving the assets and/or containers.

In this manner, the asset tracking system may more efficiently manage deliveries across multiple facilities or yards. In this manner, the asset tracking system may have virtual map data and vehicle delivery data as well as status and location (e.g., region) for each asset on premise, arriving, and/or departing the yard during operations (e.g., in substantially real-time). Accordingly, the scheduling system discussed herein may estimate (such as via one or more machine learned models) operation times associated with each unloading and loading event based on the type of operation, the location of the assets, and the like. The system may also determine location and/or accessibility of the assets (e.g., is the asset within a container at the bottom of a vertical stack of containers) and/or alternative assets (e.g., more accessible assets) based on virtual map data and associated region. The asset tracking system may then schedule use of the loading and unloading areas (e.g., the bay doors) based on an optimization to improve the overall flow of assets in and out of the yard.

As additional illustrative examples, the asset tracking system may schedule assets to remain in a prep area as opposed to directing the deliveries to yard regions for storage or shelving when the assets will be reloaded shortly. In some cases, if the yard storage is full or near full (e.g., greater than or equal to a threshold number of regions are occupied), the asset tracking system may utilize down time to schedule an unloading/reloading operation to unload assets that are low in inventory while reloading the containers with assets that have a high inventory count or the system determines will not be used as quickly as the unloaded assets. Thus, while the asset tracking system may cause additional loading and unloading operations or events, the asset tracking system may utilize the additional operations to improve the overall flow of assets in and out of the yard.

In some cases, since the asset data received may be from different sources or types of image devices at different ranges and generalities, the asset tracking system may perform a data normalization using techniques such as threshold-based data normalization and machine learning algorithms to identify the driver, vehicle, or container. It should be understood that the asset tracking system may utilize different weighted averages or thresholds based on the data source (e.g., sensor type, location, distance, and position), the current weather (e.g., sunny, rainy, snowy, or foggy), and time of day when performing data normalization. In some cases, machine learning algorithms may also be applied to remove the distortion from images caused by rain, dust, sand, fog, and the like as well as to brighten the sensor and/or images shot in low-light or dark conditions.

As described herein, the machine learned models may be generated using various machine learning techniques. For example, the models may be generated using one or more neural network(s). A neural network may be a biologically inspired algorithm or technique which passes input data (e.g., image and sensor data captured by the IoT computing devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications (e.g., vehicle identifier, container identifier, driver identifier, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

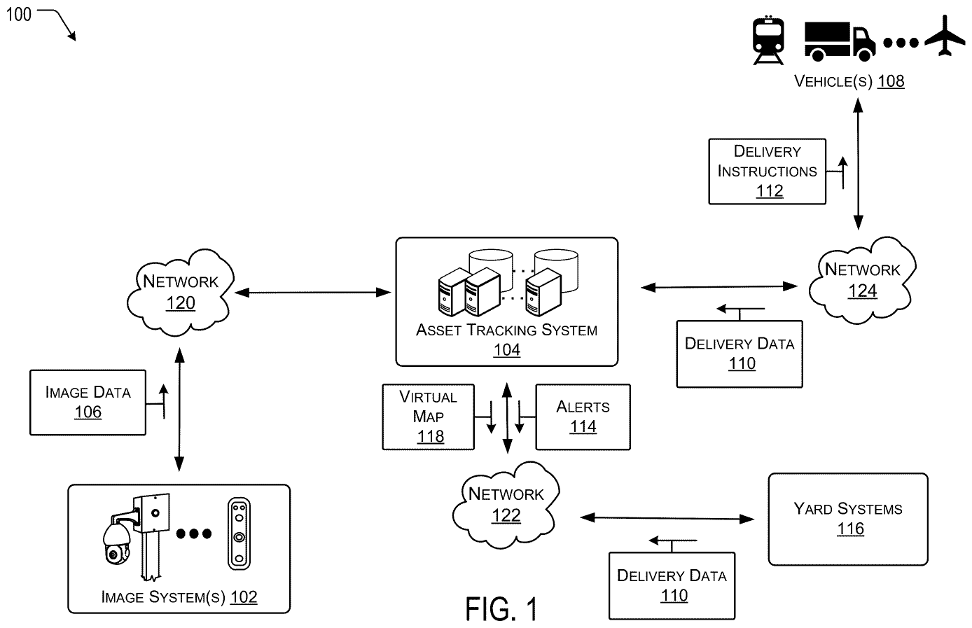

FIG. 1 is an example block diagram of an image device 102 (such as a PTZ image device) and an asset tracking system 104 for mapping yards and tracking and recording asset and container locations within the yard grounds, according to some implementations. For example, as a vehicle (e.g., a truck, rail car, ship, or the like) approaches an entry or exit point of the yard (e.g., a storage facility, warehouse, port, holding yard, commercial establishment, and the like), one of the one or more image devices 102 may be configured to detect the vehicle and capture image data 106 (e.g., video data, image data, depth data, and the like) associated with the vehicle, one or more driver(s) of the vehicle, and/or one or more container(s), crate(s), or pallet(s), and the like associated with the vehicle.

The captured image data 106 may be used to verify information associated with the assets, such as the vehicle, driver, container and/or contents of the container, and the like. In some instances, the asset tracking system 104 may process the image data 106, for instance, using one or more machine learned model(s) (such as trained on image data including vehicles, container, and the like as well as identifiers, such as government identifiers, corporate identifiers, and the like) to segment, classify, and identify the desired information (e.g., the information associated with the asset). In some cases, each of the desired identifiers may be associated with independent heads of the machine learned model. In other examples, the processing may be split between the asset tracking system 104 and on the devices 102, such as when an IoT device, NVR device, or EDGE computing device is utilized.

In some examples, the image data 106 may also be utilized to determine a state or status of the assets and/or container. For example, the state or status may be used to determine if damage occurred during shipping and/or if any repairs to the vehicle, container, or chassis are necessary before redeployment. In some instances, additional machine learned models may be employed by the image system 102 and/or the asset tracking system 104 to detect damage or other wear and tear of the assets, vehicle, container, chassis, and/or the like.

In some specific examples, the image systems 102 may include infrared, thermal, depth, or other types of sensors capable of imaging or generating image data 106 associated with the contents of the container without opening the container. In these examples, the image data 106 may also be used to detect any damage caused to the contents of the containers or packages. For instance, the sensor system 102 and/or the cloud-based system 104 may compare the captured sensor data 106 and/or the status output by the machine learned models to a recorded status of the assets, vehicle, container, and/or chassis associated with the vehicle, container, and/or chassis at the time of deployment (e.g., as last captured by a yard that previously housed the assets).

In the current example, the asset tracking system 104 may be configured to determine a region of a plurality of predefined or defined on-the-fly regions associated with the yard that is suitable for receiving the assets and/or container being delivered by a vehicle 108. For example, the asset tracking system 104 may have predefined regions configured to receive various types of assets and/or containers, such as a yard with predefined trailer parking locations. In other cases, the asset tracking system 104 may generate the regions on-the-fly or based on current occupancy, such as when the yard does not include predefined regions (such as a port yard, junk yard, or other yard that does not receive assets in universal sized containers).

In some cases, the asset tracking system 104 may also select a region for receiving the assets and/or container being delivered based on characteristics and/or features of the asset and/or container as well as the vehicle 108. For example, the asset tracking system 104 may segment, classify, and/or otherwise detect the characteristics and/or features of the assets and container based on the image data 106, such as via an output of one or more machine learned models trained on image data of various types of vehicles, containers, and the like together with known conditions as pairs of inputs and/or results that receive the image data or portions of the image data as an input.

In other cases, the vehicles 108 may send delivery data 110, such as schedule, estimated time of arrival, asset data, container data, vehicle data, driver data, and the like, to the asset tracking system 104. In these cases, the asset tracking system 104 may utilize the delivery data 110 together with the sensor data 106 to determine characteristics and/or features of the asset and/or container and/or the vehicle 108. In the current example, the delivery data 110 is shown as received from the vehicles 108, however, it should be understood that the delivery data 110 may be received from various systems, such as the departing facility systems, a shipping system, a scheduling system, and the like.

In some cases, the asset tracking system 104 may utilize the delivery data 110 to provide instructions to, for instance, yard equipment or personnel to move or reposition various assts within the yard or facility prior to an arrival of one or more additional vehicles. In this manner, the system 104 may preemptively adjust the regions within the yard and the yard capacity to accommodate different types of vehicles, containers, or the like as the vehicles and/or containers are in route (e.g., prior to arrival at the facility). Accordingly, the facility may avoid or mitigate delays or slowdowns caused by vehicle arrivals without sufficient yard or facility space (e.g., caused by retroactive rearrangement of the yard or facility).

In this example, the asset tracking system 104 may select the region based on the characteristics and/or features of the asset (such as a dimensions, size, weight, and the like) and the availability or occupancy of the regions associated with the yard. In some cases, the asset tracking system 104 may also select the region based on shipping schedules, upcoming events (such as loading/unloading), availability of personnel and yard vehicles, other incoming deliveries, and the like. For example, the asset tracking system 104 may select a first region when the assets and/or containers may be stored for a prolonged period of time at the yard and a second region when the assets will be shipped from the yard in a relatively short period of time. In some cases, the asset tracking system 104 may determine or track an estimated yard time for each asset and/or container based on delivery schedules, inventory levels, yard capability and availability (e.g., size, space, personnel, vehicles, equipment, and the like). The asset tracking system 104 may then assign regions based on comparative rankings associated with the estimated yard time per asset and/or container.

Once a region is selected by the asset tracking system 104, the asset tracking system 104 may send delivery instructions 112 to the vehicle 108 including the assigned delivery location or region. In some cases, the asset tracking system 104 may send the delivery instructions 112 to one or more displays associated with the yard. The display may include the delivery region, instructions or maps of the yard to assist the driver in delivering the assets and/or containers to the assigned region, estimated wait times if any (such as when too many vehicles are delivering or picking up assets at substantially the same time), and the like. In other cases, the asset tracking system 104 may send the delivery instructions 112 to a device associated with the driver or vehicle, such as a smart phone, tablet, vehicle display, or the like.

As the vehicle 108 navigates through the yard to the assigned region, one or more of the image devices 102 may track and capture image data 106 associated with the delivery event, as discussed herein. In some cases, once the asset tracking system 104 confirms delivery of the assets to the region via the image data 106, the asset tracking system 104 may send an alert 114 to a yard system 116 to notify a yard operator as to a completion of the delivery event. The asset tracking system 104 may also update a virtual map 118 of the yard to indicate the asset and/or container is occupying the specified region.

As discussed above, the virtual map 118 may include a two-dimensional map (such as an overhead or top-down map) and/or three-dimensional map of the yard with data indicating the occupancy. In some cases, the virtual map 118 may also include the determined characteristics and/or features of the assets and/or container in each region, aggregated data (such as number of each asset or item), schedule data (such as next delivery data, upcoming or real-time event data, and the like), estimates, delays, issue alerts (such as a stalled vehicle in the yard, failed yard equipment, or the like), and the like. In some cases, a yard operator may be able to utilize the virtual map 118 to assign regions manually (such as by selecting specific delivery vehicles 108 and/or specific regions), redefine regions (such as dividing regions, combining regions, and the like), as well as to override scheduled instructions (such as order of delivery or pickups and the like). For example, the yard system 116 may allow the operator to cause the asset tracking system 104 to send delivery data 110 to the vehicles 108.

In some cases, the asset tracking system 104 may also generate recommendations for the yard operator, such as recommended assets and/or containers to region assignments, delivery orders, personnel or equipment assignments, and the like. In some cases, the asset tracking system 104 may provide the recommendations via the virtual map 118 (such as via a selection option, color indication—e.g., red for issues or conflicts, yellow for recommendations or pending decisions, and green for assigned or the like).

In some cases, if the vehicle 108 delivers the asset to an incorrect region, the asset tracking system 104 may send an alert to the vehicle 108 or the driver to notify the driver prior to the vehicle 108 exiting the yard in addition to an alert 114 sent to the yard system 116. In some cases, if the asset or container is delivered to the incorrect region, the asset tracking system 104 may update the occupancy data of a virtual map 118 while regenerating assignments to accommodate the erroneous delivery. In this manner, the asset tracking system 104 is able to identify errors and correct them without requiring event task to be performed by personnel (such as moving assets or containers after delivery to a different region). Rather, as discussed herein, the asset tracking system 104 may swap regions or allow for the correction of the error to be performed upon the next task or event associated with the erroneously placed asset and/or container while maintaining a record of the location or region associated with the asset and/or container, thereby preventing loss of items.

In the current example, the data, alerts, maps, instructions, and the like may be transmitted between various systems using networks, generally indicated by 120-124. The networks 120-124 may be any type of network that facilitates compunction between one or more systems and may include one or more cellular networks, radio, WiFi networks, short-range or near-field networks, infrared signals, local area networks, wide area networks, the internet, and so forth. In the current example, each network 120-124 is shown as a separate network but it should be understood that two or more of the networks may be combined or the same.

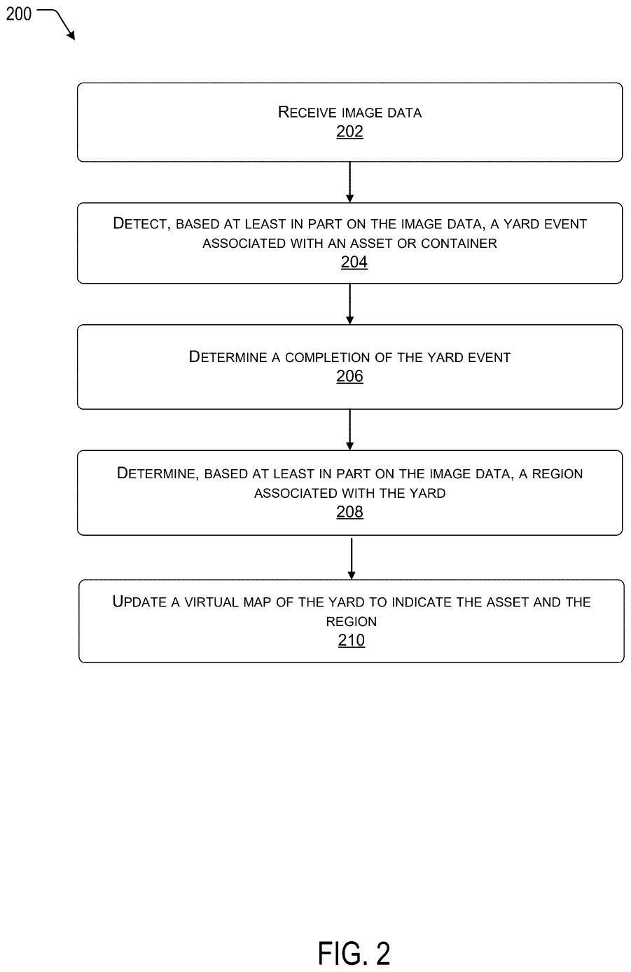

FIGS. 2-5 are flow diagrams illustrating example processes associated with the scheduling system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 is a flow diagram illustrating an example process 200 associated with the asset tracking system of FIG. 1, according to some implementations. As discussed herein, the asset tracking system may be configured to automate tracking of assets within a yard without use of per asset tags. For example, many conventional systems may require an asset tag to be attached to each asset and/or container as the asset or container enters the yard and removed as each asset or container exits the yard. A scanner can then be configured to detect the asset tags within the yard to identify the desired asset or container. However, attaching and removing the tags as well as traversing the yard to detect the asset requires significant resources (e.g., personnel and hardware) and time (e.g., in scanning the yard for a specific or desired asset). Alternatively, the asset tracking system discussed herein, may track and store location data associated with assets within the yard without the need to attach tags to specific assets or containers and without requiring a system, a vehicle, or personnel to scan the yard in search of the asset, thereby improving speed of operations, accuracy and visibility of data associated with assets stored within the yard, and reducing overall yard operational costs.

At 202, the asset tracking system may receive image data from one or more sensors associated with a yard. For example, the system may include one or more PTZ image devices positioned within the yard. For instance, one image device may be utilized for each delivery vehicle that may enter the yard at a given time (e.g., if three vehicles are able to load and unload at a time, the system may utilize three image devices). In other cases, the asset tracking system may utilize one additional image device than the number of delivery vehicles that may enter the yard at a given time. In some examples, the image devices may be fixed, such as along the edge of the yard, on towers within the yard grounds, associated with the yard equipment, operators, and/or vehicles (such as mounted on forklifts and/or attached to facility operator's vests or helmets, and the like).

In some cases, the PTZ image device may be configured to perform predetermined scans of the yard or physical environment. For example, the PTZ image device may rotate or spin such that the PTZ image device is able to zoom in and capture detailed image data associated with defined regions of the yard once per scan or period of time (such as once every minute, once every half a minute, or the like). In other cases, the PTZ image devices may be configured to detect delivery vehicles, loading/unloading events, and the like and track the vehicle and/or event as the assets are loaded, unloaded, or otherwise moved within the yard. In the case of multiple PTZ image devices, each device may be assigned to track a different event or vehicle and/or to track events and/or vehicles within predefined field of views. For example, a delivery vehicle moving through a yard may be first tracked by a first PTZ image device within a first field of view associated with the first PTZ image device and then transitioned to be tracked by a second PTZ image device when the vehicle enters a second field of view associated with the second PTZ image device. In another example, the first PTZ image device may track a first vehicle within the yard and the second PTZ image device may track a second vehicle within the yard. In one specific example, the asset tracking system may implement a first set of PTZ image devices where each PTZ image device of the set tracks individual vehicles and a second set of PTZ image devices that scan the yard, as discussed above.

At 204, the asset tracking system may detect, based at least in part on the image data, a yard event associated with an asset or container. For example, the asset tracking system may detect a delivery or shipping event (e.g., loading or unloading of assets or containers within the yard) based on the image data. In some cases, the image data may be streamed in substantially real-time to the asset tracking system from the one or more image devices, such that the image data may be parsed, segmented, and/or classified in substantially real-time to detect the events associated with the yard. In some cases, one or more machine learned models and/or networks may be utilized to detect the event. In some cases, the machine learned models and networks may be trained using image data of one or more yards as assets are delivered and shipped from each yard.

At 206, the asset tracking system may determine a completion of the yard event. For example, the system may determine based at least in part on the image data that the assets or containers are delivered to, shipped from, or otherwise moved within the yard.

At 208, the asset tracking system may determine, based at least in part on the image data, a region associated with the yard. For example, the asset tracking system may generate a virtual map, grid, or other type of location mapping associated with the yard. The virtual map may be divided into one or more regions and each region may be associated with a storage location for assets and/or containers. In some cases, the regions may be predefined or otherwise fixed. In other examples, the regions may be defined on-the-fly by the asset tracking system based on one or more characteristics of the assets and/or containers (such as the dimensions, weight, the like of the asset or container).

At 210, the asset tracking system may update a virtual map of the yard to indicate the asset and the region. For instance, the virtual map may be updated to show the region as occupied by the asset or container that was detected in the image data. In some cases, the virtual map may include additional data such as date/time of delivery, age of the assets, type of assets or containers, asset or container characteristics (e.g., weight, dimensions, stackability ratings or metrics, number of assets, and the like), identifiers or IDs associated with the assets or containers, data on the delivery vehicle (e.g., driver identifiers and metrics-on time percentages, typical routes, and the like, vehicle identifiers and metrics, any scheduled events associated with the region and/or assets or containers, and the like). In some cases, the virtual map may be updated in substantially real-time such that a yard operator may receive real-time inventory data which may be utilized by the operator and/or the asset tracking system or other scheduling system to schedule or assign tasks or events associated with the operations of the yard.

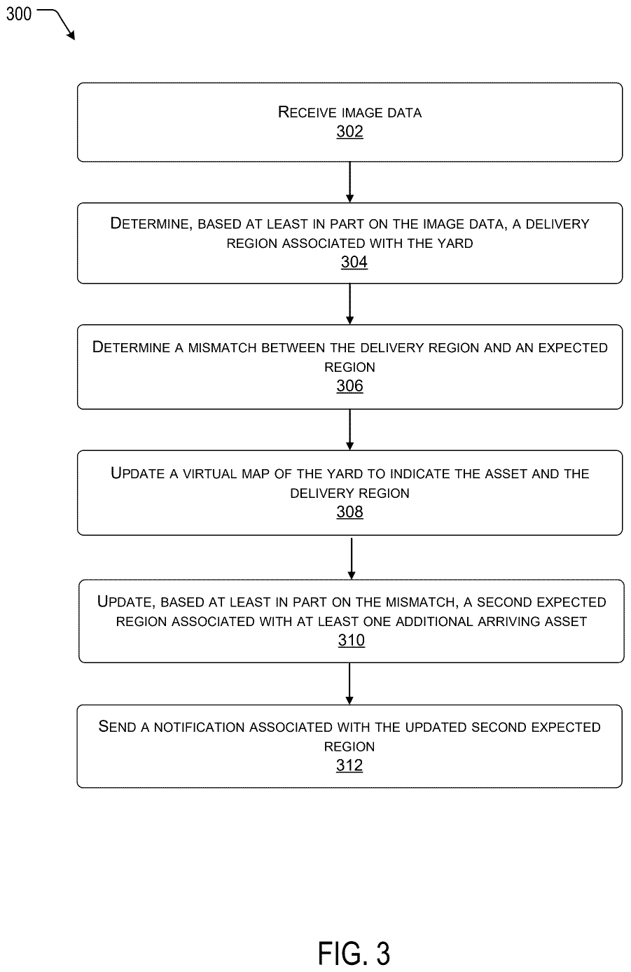

FIG. 3 is another flow diagram illustrating an example process 300 associated with the asset tracking system of FIG. 1, according to some implementations. As discussed above, the asset tracking system may utilize captured image data representing loading and unloading events within a yard to generate and/or maintain a virtual map or other asset locating record.

At 302, the asset tracking system may receive image data from one or more sensors associated with a yard. For example, the system may include one or more PTZ image devices positioned within the yard. For instance, one image device may be utilized for each delivery vehicle that may enter the yard at a given time (e.g., if three vehicles are able to load and unload at a time, the system may utilize three image devices). In other cases, the asset tracking system may utilize one additional image device than the number of delivery vehicles that may enter the yard at a given time. In some examples, the image devices may be fixed, such as along the edge of the yard, on towers within the yard grounds, associated with the yard equipment, operators, and/or vehicles (such as mounted on forklifts and/or attached to facility operator's vests or helmets, and the like).

At 304, the asset tracking system may determine, based at least in part on the image data, a region associated with the yard. For example, the asset tracking system may generate a virtual map, grid, or other type of location mapping associated with the yard. The virtual map may be divided into one or more regions and each region may be associated with a storage location for assets and/or containers. In some cases, the regions may be predefined or otherwise fixed. In other examples, the regions may be defined on-the-fly by the asset tracking system based on one or more characteristics of the assets and/or containers (such as the dimensions, weight, the like of the asset or container).

At 306, the asset tracking system may determine a mismatch between the delivery region (e.g., the region an asset or container was actually delivered to) and an expected region (e.g., the region the asset or container was intended to be delivered to). For example, the system may determine based on processed image data that a delivery event has ended and that the region that the asset or container is occupying is not the expected region.

At 308, the asset tracking system may update a virtual map of the yard to indicate the asset and the delivery region. For instance, the virtual map may be updated to show the region as occupied by the asset or container that was detected in the image data. In some cases, the virtual map may include additional data such as date/time of delivery, age of the assets, type of assets or containers, asset or container characteristics (e.g., weight, dimensions, stickability ratings or metrics, number of assets, and the like), identifiers or IDs associated with the assets or containers, data on the delivery vehicle (e.g., driver identifiers and metrics-on time percentages, typical routes, and the like, vehicle identifiers and metrics, any scheduled events associated with the region and/or assets or containers, and the like). In some cases, the virtual map may be updated in substantially real-time such that a yard operator may receive real-time inventory data which may be utilized the operator and/or the asset tracking system or other scheduling system to schedule or assign tasks or events associated with the operations of the yard.

At 310, the asset tracking system may update, based at least in part on the mismatch, a second expected region associated with at least one additional arriving asset. For example, the system may generate instructions to cause additional or newly arriving assets or containers to be directed to different regions based on the delivery region not being the expected region. In this manner, the system may update or reroute assets and containers within the yard in substantially real-time and, thereby, avoid delays when the additional or new assets arrive with no region for storage (e.g., upon a later discovery that the region for the new assets is occupied). The system may also avoid additional tasks of moving items and containers within the yard by rerouting incoming assets and containers to currently available regions and/or by defining additional regions.

At 312, the asset tracking system may send a notification or alert associated with the updated second expected region. For example, the system may send the notification or alert to a delivery vehicle, device associated with a driver, a third-party system, or the like to notify a responsible entity that the delivery instructions have been updated. In some cases, the system may update a display associated or provided for arriving vehicles with the second expected region, such that upon arrival the driver may confirm the region using the display.

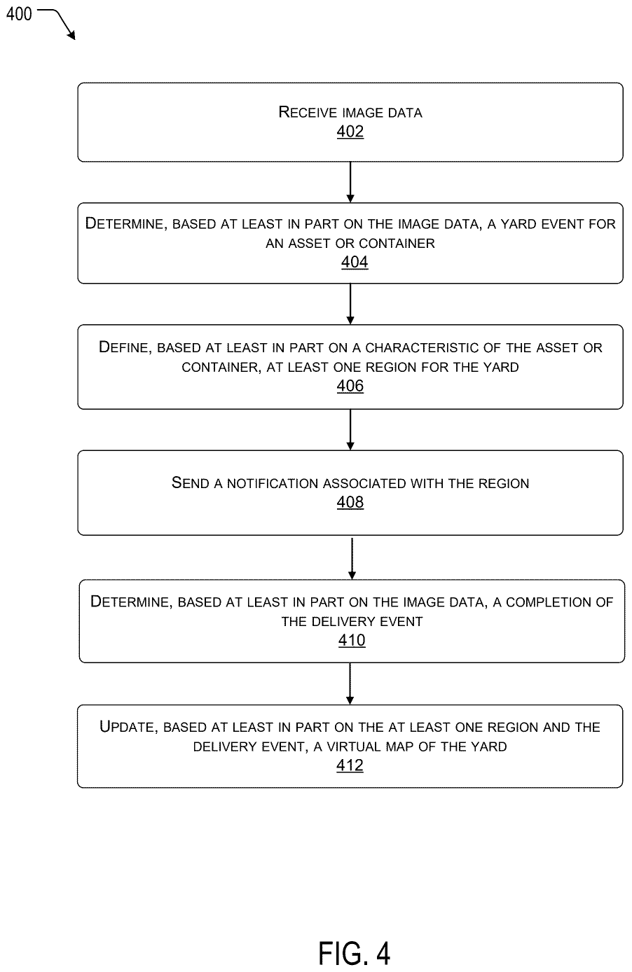

FIG. 4 is another flow diagram illustrating an example process 400 associated with the asset tracking system of FIG. 1, according to some implementations. As discussed above, in some implementations, the asset tracking system may define regions of the yard based on the current occupancy and characteristics of the stored assets and containers. For example, in a shipping yard the containers may be stacked vertically and horizontally in an ad-hoc fashion that may result in containers of differing size and positions being stored at different positions and/or orientations over time.

At 402, the asset tracking system may receive image data from one or more sensors associated with a yard. For example, the system may include one or more PTZ image devices positioned within the yard. For instance, one image device may be utilized for each delivery vehicle that may enter the yard at a given time (e.g., if three vehicles are able to load and unload at a time, the system may utilize three image devices). In other cases, the asset tracking system may utilize one additional image device than the number of delivery vehicles that may enter the yard at a given time. In some examples, the image devices may be fixed, such as along the edge of the yard, on towers within the yard grounds, associated with the yard equipment, operators, and/or vehicles (such as mounted on forklifts and/or attached to facility operator's vests or helmets, and the like).

At 404, the asset tracking system may determine, based at least in part on the image data, a yard event for an asset or container. For example, the system may detect by parsing, segmenting, classifying, or otherwise analyzing the image data that a delivery vehicle is approaching or has entered the yard. In other cases, the asset tracking system may detect loading events, assets being moved about the yard by an operator, yard equipment, or the like. In some cases, the asset tracking system may identify (e.g., determine an identity of) characteristics or features (e.g., dimensions, weight, materials, type, and the like) of the asset, container, vehicle, driver, yard personnel, yard equipment, or the like associated with the yard event.

At 406, the asset tracking system may define, based at least in part on characteristics of the asset or container, at least one region for the yard to associate with the yard event. For example, the asset tracking system may define a region from an unoccupied area based on the dimensions and/or weight of the assets or container associated with the yard event. In some cases, the region may be defined both horizontally (along the ground surface) and/or vertically. For example, the defined region may be positioned atop another container, under an overhang (such as roof, tarp, or the like) and the like. In some cases, the region may also be defined based at least in part on characteristics of the vehicle, driver, yard equipment, yard personnel, or the like. For example, a larger region may be defined if the delivery vehicle or yard equipment requires additional room to maneuver the assts and/or containers into position.

At 408, the asset tracking system may send a notification associated with the region. For example, the system may send a notification to the driver, yard operator, delivery vehicle, a third-party system associated with the assets and/or containers, or the like. In some cases, the notification may include the region and/or instructions for traversing the yard to the region. In some examples, the notification may be sent to a display that is visible to drivers, yard personnel, vehicle or the like that are entering, exiting, or otherwise waiting within the yard for an invitation of a specific yard event.

At 410, the asset tracking system may determine, based at least in part on the image data, a completion of the delivery event. For example, once the notification is sent to one or more devices or systems to notify various parties as to the region, the system may receive additional image data of the yard that includes or otherwise represents (such as via one or more frames) the delivery event from initiation to completion. The system may parse the additional image data to determine the completion. In some cases, one or more machine learned models trained on yard delivery image data may be used to determine the completion.

In some cases, the asset tracking system may also rate, score, or otherwise rank the parties invited in the delivery event. For example, the system may score based on timeliness (e.g., how long did the delivery event take compared to average delivery events, expected delivery events, or the like). In some cases, the scores may be used to evaluate yard equipment, yard personnel, drivers or vehicle operators, vehicles, companies associated with the vehicles, and the like. The scores may also be used for process improvement type activities at the yard.

At 412, the asset tracking system may update, based at least in part on the region and the delivery event, a virtual map of the yard. For example, the system may update the virtual map such that the map represents the occupation of the region by the asset or container. In some cases, the virtual map may include data, characteristics, features, or the like of the assets and/or container within the occupied region. In some cases, the virtual map may also include scheduling data associated with the region (such as a pickup or shipping event associated with the assets or container at the region).

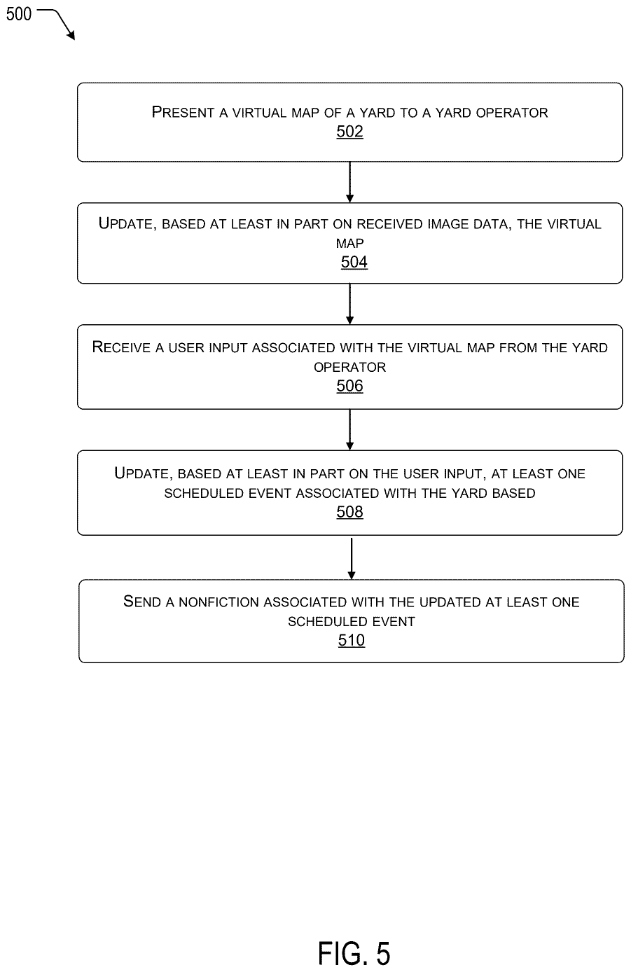

FIG. 5 is another flow diagram illustrating an example process 500 associated with the asset tracking system of FIG. 1, according to some implementations. As discussed above, the asset tracking system may provide a virtual map or other user interface that may allow a yard operator to survey, manage, and/or track assets, containers, yard equipment and/or personnel, vehicles, vehicle operators, and the like as well as tasks and events happing within the yard.

At 502, the asset tracking system may present a virtual map of a yard to a yard operator. For example, the asset tracking system may provide the virtual map to the yard operator via a user interface that may be accessed via an electronic device or display. In some cases, the virtual map may be provided as part of a downloadable application that has access to the asset tracking system as a local-wireless and/or cloud-based service.

At 504, the asset tracking system may update, based at least in part on received image data, the virtual map of the yard, such as to indicate asset or container allocation or occupancy changes with respect to one or more regions of the yard. For instance, the virtual map may be updated to show the region as occupied by the asset or container that was detected in the image data. In some cases, the virtual map may include additional data such as date/time of delivery, age of the assets, type of assets or containers, asset or container characteristics (e.g., weight, dimensions, stackability ratings or metrics, number of assets, and the like), identifiers or IDs associated with the assets or containers, data on the delivery vehicle (e.g., driver identifiers and metrics-on time percentages, typical routes, and the like, vehicle identifiers and metrics, any scheduled events associated with the region and/or assets or containers, and the like). In some cases, the virtual map may be updated in substantially real-time such that a yard operator may receive real-time inventory data which may be utilized the operator and/or the asset tracking system or other scheduling system to schedule or assign tasks or events associated with the operations of the yard.

At 506, the asst tracking system, via the electronic device or display, may receive a user input associated with the virtual map from the yard operator. For example, the yard operator may select assets, containers, vehicles, yard equipment, yard personnel, regions, and the like to assign tasks to be performed as yard events. In some cases, the user input may include selected instructions, user defined instructions, and the like. In some cases, the asset tracking system may make recommendations for assignment of tasks that the yard operator may select. In some examples, the instructions may be generated via one or more machine learned models or networks.

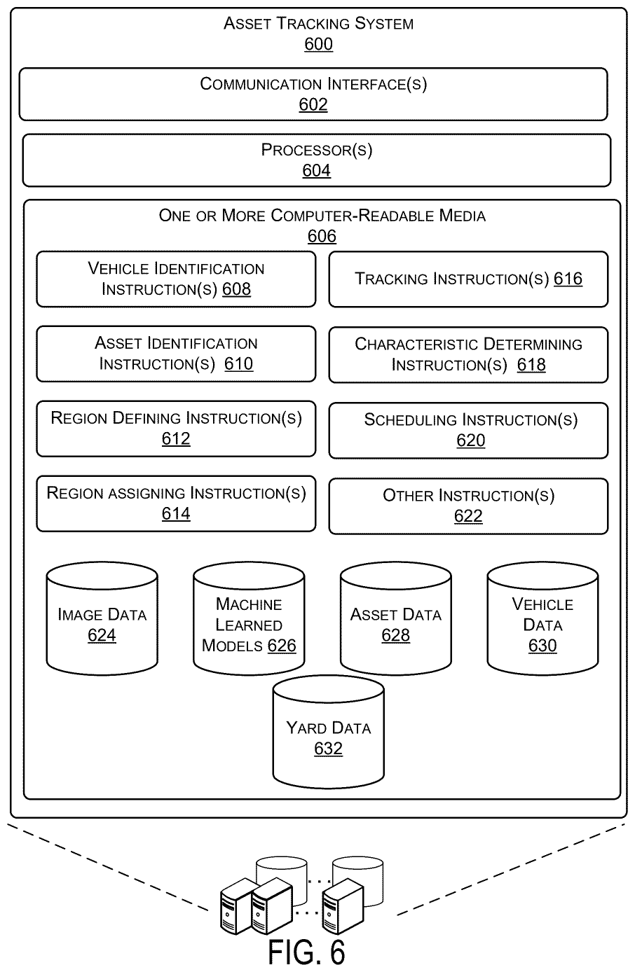

FIG. 6 is an example asset tracking system 600 that may implement the techniques described herein according to some implementations. The asset tracking system 600 can include one or more communication interface(s) 602 that enable communication between the asset tracking system 600 and one or more other local or remote computing device(s) or remote services, such as the PTZ image devices. For instance, the communication interface(s) 602 can facilitate communication with other proximate sensor systems and/or other facility systems. The communications interfaces(s) 602 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The asset tracking system 600 may include one or more processors 604 and one or more computer-readable media 606. Each of the processors 604 may itself comprise one or more processors or processing cores. The computer-readable media 606 is illustrated as including memory/storage. The computer-readable media 606 may include volatile media (such as random access memory (RAM)) and/or nonvolatile media (such as read only memory (ROM), Flash memory, optical disks, magnetic disks, and so forth). The computer-readable media 606 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Several modules such as instructions, data stores, and so forth may be stored within the computer-readable media 606 and configured to execute on the processors 604. For example, as illustrated, the computer-readable media 606 stores vehicle identification instructions 608, asset identification instructions 610, region defining instructions 612, region assigning instructions 614, tracking instructions 616, characteristic determining instruction 618, scheduling instruction 620, as well as other instructions 622, such as an operating system. The computer-readable media 606 may also be configured to store data, such as image data 624, machine learned models 626, asset data 628, vehicle data 630, yard data 632 as well as other data.

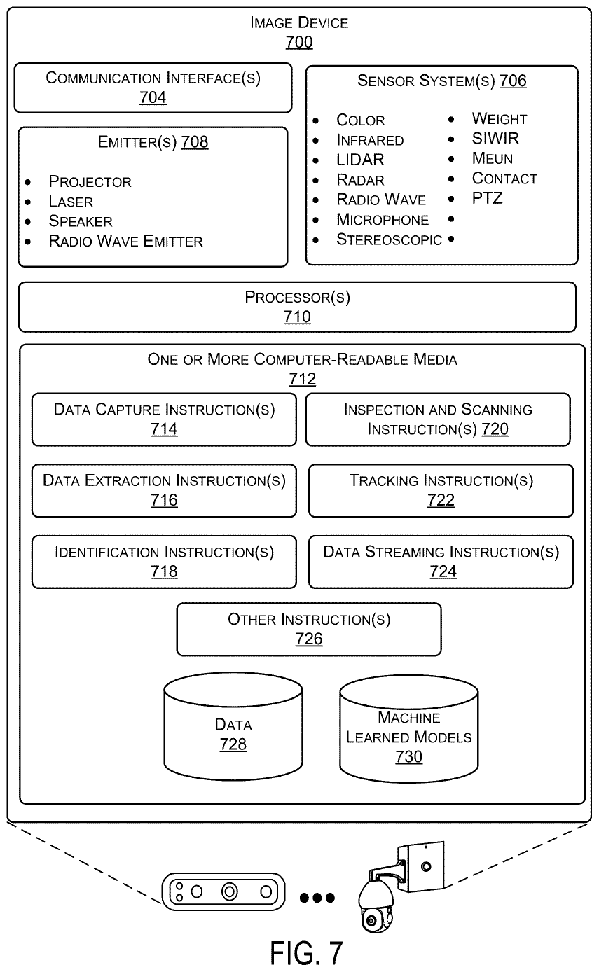

FIG. 7 is an example image device 700 that may implement the techniques described herein according to some implementations. The image device 700 may include one or more communication interface(s) 704 (also referred to as communication devices and/or modems), one or more sensor system(s) 706, and one or more emitter(s) 708.

The image device 700 can include one or more communication interfaces(s) 704 that enable communication between the image device 700 and one or more other local or remote computing device(s) or remote services, such as a cloud-based asset tracking system of FIG. 1. For instance, the communication interface(s) 704 can facilitate communication with other proximate sensor systems, a central control system, or other facility systems. The communications interfaces(s) 504 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The one or more sensor system(s) 706 may be configured to capture the data 728 associated with a yard. In at least some examples, the sensor system(s) 706 may include thermal sensors, time-of-flight sensors, location sensors, LIDAR sensors, SIWIR sensors, radar sensors, sonar sensors, infrared sensors, cameras (e.g., RGB, IR, intensity, depth, etc.), Muon sensors, microphone sensors, environmental sensors (e.g., temperature sensors, humidity sensors, light sensors, pressure sensors, etc.), PTZ cameras, and the like. In some examples, the sensor system(s) 706 may include multiple instances of each type of sensor. For instance, camera sensors may include multiple cameras disposed at various locations.

The image device 700 may also include one or more emitter(s) 708 for emitting light and/or sound. By way of example and not limitation, the emitters in this example include light, illuminators, lasers, patterns, such as an array of light, audio emitters, and the like.

The image device 700 may include one or more processors 710 and one or more computer-readable media 712. Each of the processors 710 may itself comprise one or more processors or processing cores. The computer-readable media 712 is illustrated as including memory/storage. The computer-readable media 712 may include volatile media (such as random access memory (RAM)) and/or nonvolatile media (such as read only memory (ROM), Flash memory, optical disks, magnetic disks, and so forth). The computer-readable media 712 may include fixed media (e.g., RAM, ROM, a fixed hard drive, and so on) as well as removable media (e.g., Flash memory, a removable hard drive, an optical disc, and so forth). The computer-readable media 712 may be configured in a variety of other ways as further described below.

Several modules such as instructions, data stores, and so forth may be stored within the computer-readable media 712 and configured to execute on the processors 710. For example, as illustrated, the computer-readable media 712 stores data capture instructions 714, data extraction instructions 716, identification instructions 718, inspection and scanning instructions 720, tracking instructions 722, data streaming instruction 724, as well as other instructions 726, such as an operating system. The computer-readable media 712 may also be configured to store data, such as sensor data 728, machine learned models 730, and the like.

The data capture instructions 714 may be configured to utilize or activate the emitters 708 and/or the sensor systems 706 to capture data associated with assets, containers, vehicles, drivers, yard equipment or yard personnel, packages, chassis, or other transportation related system or vessel. In some cases, the data capture instructions 714 may select between individual sensor systems 706 based on a current weather, visibility, light, time of day, time of year, physical location, type and/or size of vehicle, type and/or size of container, number of containers, and the like.

The data extraction instructions 716 may be configured to input the captured sensor data 728 into one or more machine learned models 730 to generate and/or extract features and characteristics associated with the assets, containers, vehicles, equipment, personnel, and/or the like. The data may be extracted from the exterior or interior of the vehicle or containers, documents associated with the vehicle or containers, and the like. For example, the data extraction instructions 716 may include the dimensions or weight of the asset or container, as discussed above.

The identification instructions 718 may be configured to determine an identity of the vehicle, asset, container, personnel, equipment, and the like. For example, the identification instructions 718 may utilize one or more machine learned models 730 with respect to the sensor data 728 to determine the identity or type of asset, as discussed above.

The inspection and scanning instructions 720 may be configured to control the sensor systems 706. For example, the inspection and scanning instructions 720 may cause individual sensor systems 706 of the image device to scan a predefined portion of the yard and zoom in on specific regions as discussed above.

The tracking instructions 722 may be configured to control the sensor systems 706. For example, the tracking instructions 722 may cause individual sensor systems 706 of the image device to detect a vehicle, asset, or container and to track the position (via image data) as the vehicle, asset, or container is moved with respect to the regions of the yard, as discussed above.

The data streaming instructions 724 may cause the image device 700 to send or stream the captured data to a cloud-based service or local wireless service via the communication interfaces 704. For example, the data streaming instructions 724 may stream the captured data to an asset tracking system, as discussed herein.

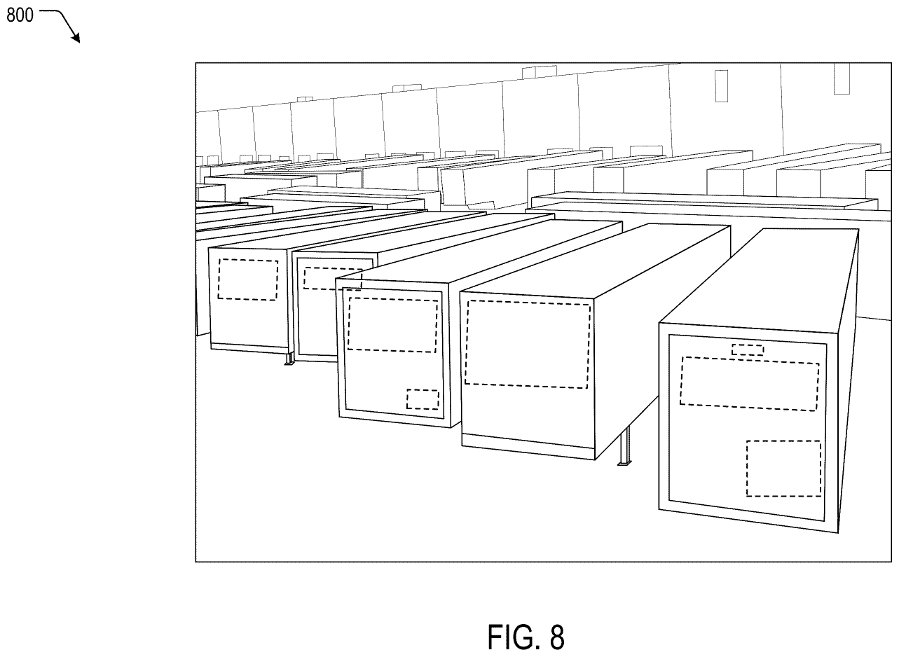

FIG. 8 is an example pictorial diagram 800 that shows a yard with multiple containers that may be scanned to determine regions and identification data as described herein according to some implementations.

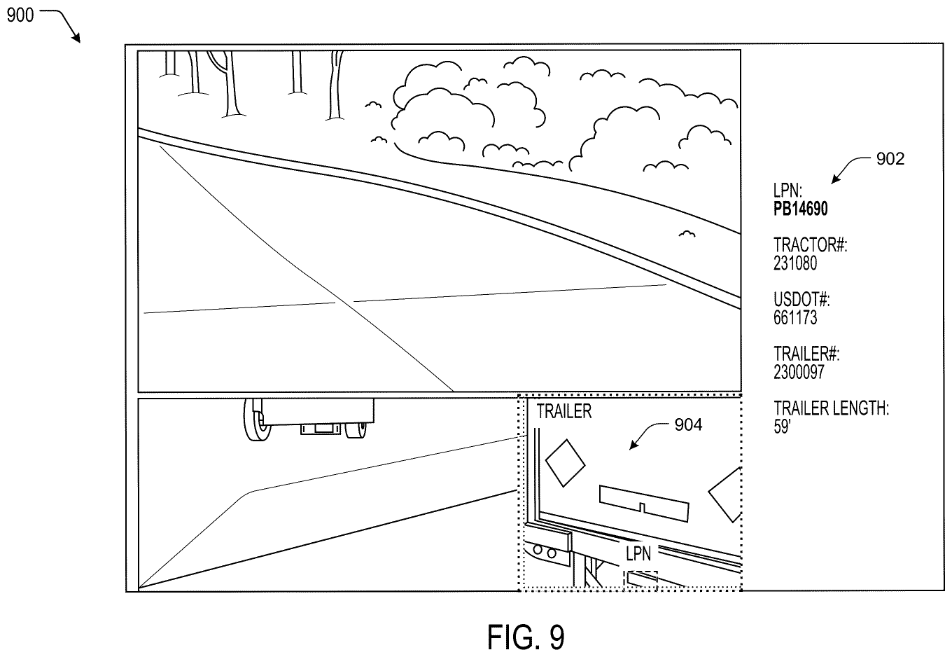

FIG. 9 is an example pictorial diagram 900 that shows a vehicle being identified as the vehicle enters a yard according to some implementations. As illustrated, the system may identify various identifiers, generally indicated as 902, from the image data 904 of the vehicle as the vehicle is moving through the field of view of the image devices, as shown.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

### EXAMPLE CLAUSES

A. A method comprising: receiving, from a first image device, first image data of a facility, the first image data representing a first vehicle; receiving, from a second image device, second image data of the facility; generating, based at least in part on the first image data and the second image data, a virtual map of the facility, the virtual map including a first set of regions defined based at least in part on existing stationary assets within the facility; responsive to determining, based at least in part on the first image data, an identity of the first vehicle, determining at least one characteristic associated with a first asset associated with the first vehicle; generating, based at least in part on the at least one characteristic associated with the first asset, a second set of regions associated with the virtual map, the second set of regions replacing the first set of regions and the second set of regions different than the first set of regions; assigning a first designated region of the second set of regions to the first vehicle; and presenting the virtual map representing the second set of regions on a display associated with the facility.
B. The method of A, further comprising: sending, to a device associated with the first vehicle, instructions associated with delivery of the first asset to the first designated region.
C. The method of B, wherein the instructions include the virtual map.
D. The method of A, wherein the virtual map includes a first virtual region of the second set of regions defined above a second virtual region.
E. The method of A, wherein generating the second set of regions associated with the virtual map is based at least in part on an estimated arrival time associated with a second vehicle delivering a second asset to the facility and at least one characteristic associated with the second asset.
F. The method of A, further comprising: determining, based at least on part on the virtual map, an estimated wait time for a second vehicle waiting to deliver at least a portion of the existing stationary assets to another location.
G. The method of A, further comprising determining, based at least in part on the first image data, a status of the first asset.
H. The method of G, wherein the status includes a metric representing any damage caused to the first asset.
I. The method of A, wherein the virtual map includes a two-dimensional top down map and a three-dimensional model of the facility.
J. The method of A, wherein the at least one characteristic associated with a first asset is one or more of the following: a weight of the first asset; dimensions of the first asset; stackability rating or metric of the first asset; packaging associated with the first asset; materials of the first assets; or item count associated with the first assets.
K. A system comprising: one or more processors; one or more image devices; and one or more computer-readable media storing instructions that, when executed by the one or more processors, cause the one or more processors to perform operations comprising: receiving, from a first image device of the one or more image device, first image data of representing a first vehicle entering a facility; determining, based at least in part on the first image data, an identity of the first vehicle; determining, based at least in part on the identity of the first vehicle, a first asset; determining, based at least in part on a virtual map of the facility and at least one characteristic associated with the first asset, a first designated region for delivery of the first asset, the virtual map including a plurality of regions representing an occupancy of the facility; and presenting the virtual map including the first designated region a display associated with the facility.
L. The system of K, wherein a first image device of the one or more image devices is a pan-tilt-zoom (PTZ) image device.
M. The system of K, wherein a first image device of the one or more image devices is a 360 degree scanning image device.
N. The system of K, wherein the operations further comprise sending an alert to a device associated with the first vehicle, the alert indicating the first designated region.
O. The system of N, wherein the operations further comprise: receiving, from a second image device of the one or more image devices, second image data of representing an unloading event associated with the first asset and the first vehicle; and updating, based at least in part on the second image data, an occupancy of the virtual map.
P. The system of O, wherein updating the occupancy of the virtual map includes changing a visual representation of the first designated region.
Q. A method comprising: receiving first image data of a facility, the first image data representing a first vehicle; receiving second image data of the facility; responsive to determining, based at least in part on the first image data, an identity of the first vehicle, determining at least one characteristic associated with a first asset associated with the first vehicle; generating, based at least in part on the first image data and the second image data, a virtual map of the facility, the virtual map including a first set of regions defined based at least in part on existing stationary assets within the facility and the at least one characteristic associated with a first asset; assigning a first designated region of the first set of regions for delivery of the first assets by the first vehicle; receiving third image data of the facility, the third image data representing the first asset subsequent to or during an unloading of the first vehicle; and determining, based at least in part on the virtual map and the third image data, a mismatch between the first designated region and a location of occupancy of the first asset.
R. The method of Q, further comprising:
sending, to a device associated with a facility operator, an alert associated with the mismatch.
S. The method of Q, wherein: generating, based at least in part on the location of occupancy of the first asset, a second set of regions associated with the virtual map and including a region associated the location of occupancy, the second set of regions replacing the first set of regions and the second set of regions different than the first set of regions; assigning the region associated the location of occupancy as a second designated region to the first asset; and presenting the virtual map representing the second set of regions on a display associated with the facility.
T. The method of claim 19, further comprising: responsive to generating the second set of regions, reassigning a second asset associated with a second vehicle enroute to the facility to a new region of the second set of regions; and sending, to a device associated with the second vehicle, an alert associated with the new region.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

1. A method comprising:
receiving, from a first image device, first image data of a facility, the first image data representing a first vehicle;
receiving, from a second image device, second image data of the facility;
generating, based at least in part on the first image data and the second image data, a virtual map of the facility, the virtual map including a first set of regions defined based at least in part on existing stationary assets within the facility;
responsive to determining, based at least in part on the first image data, an identity of the first vehicle, determining at least one characteristic associated with a first asset associated with the first vehicle;
generating, based at least in part on the at least one characteristic associated with the first asset, a second set of regions associated with the virtual map, the second set of regions replacing the first set of regions and the second set of regions different than the first set of regions;
assigning a first designated region of the second set of regions to the first vehicle; and
presenting the virtual map representing the second set of regions on a display associated with the facility.

2. The method of claim 1, further comprising:
sending, to a device associated with the first vehicle, instructions associated with delivery of the first asset to the first designated region.

3. The method of claim 2, wherein the instructions include the virtual map.

4. The method of claim 1, wherein the virtual map includes a first virtual region of the second set of regions defined above a second virtual region.

5. The method of claim 1, wherein generating the second set of regions associated with the virtual map is based at least in part on an estimated arrival time associated with a second vehicle delivering a second asset to the facility and at least one characteristic associated with the second asset.

6. The method of claim 1, further comprising:
determining, based at least on part on the virtual map, an estimated wait time for a second vehicle waiting to deliver at least a portion of the existing stationary assets to another location.

7. The method of claim 1, further comprising determining, based at least in part on the first image data, a status of the first asset.

8. The method of-claims claim 7, wherein the status includes a metric representing any damage caused to the first asset.

9. The method of claim 1, wherein the virtual map includes a two-dimensional top down map and a three-dimensional model of the facility.

10. The method of claim 1, wherein the at least one characteristic associated with a first asset is one or more of the following:
a weight of the first asset;
dimensions of the first asset;
stackabitliy rating of the first asset;
packaging associate with the first asset;
materials of the first assets; or
item count associated with the first assets.

11-20. (canceled)

21. A system comprising:
one or more processors;
one or more image devices; and
one or more computer-readable media storing instructions that, when executed by the one or more processors, cause the one or more processors to perform operations comprising:
receiving, from a first image device of the one or more image device, first image data of representing a first vehicle entering a facility;
determining, based at least in part on the first image data, an identity of the first vehicle;
determining, based at least in part on the identity of the first vehicle, a first asset;
determining, based at least in part on a virtual map of the facility and at least one characteristic associated with the first asset, a first designated region for delivery of the first asset, the virtual map including a plurality of regions representing an occupancy of the facility; and
presenting the virtual map including the first designated region a display associated with the facility.

22. The system of claim 21, wherein a first image device of the one or more image devices is a pan-tilt-zoom (PTZ) image device.

23. The system of claim 21, wherein a first image device of the one or more image devices is a 360 degree scanning image device.

24. The system of claim 21, wherein the operations further comprise sending an alert to a device associated with the first vehicle, the alert indicating the first designated region.

25. The system of claim 24, wherein the operations further comprise:
receiving, form a second image device of the one or more image device, second image data of representing an unloading event associated with the first asset and the first vehicle; and
updating, based at least in part on the second image data, an occupancy of the virtual map.

26. The system of claim 25, wherein updating the occupancy of the virtual map includes changing a visual representation of the first designated region.

27. A method comprising:
receiving first image data of a facility, the first image data representing a first vehicle;
receiving second image data of the facility;
responsive to determining, based at least in part on the first image data, an identity of the first vehicle, determining at least one characteristic associated with a first asset associated with the first vehicle;
generating, based at least in part on the first image data and the second image data, a virtual map of the facility, the virtual map including a first set of regions defined based at least in part on existing stationary assets within the facility and the at least one characteristic associated with a first asset;
assigning a first designated region of the first set of regions for delivery of the first assets by the first vehicle;
receiving third image data of the facility, the third image data representing the first asset subsequent to or during an unloading of the first vehicle; and
determining, based at least in part on the virtual map and the third image data, a mismatch between the first designated region and a location of occupancy of the first asset.

28. The method of claim 27, further comprising:
sending, to a device associated with a facility operator, an alert associated the mismatch.

29. The method of claim 27, wherein:
generating, based at least in part on the location of occupancy of the first asset, a second set of regions associated with the virtual map and including a region associated the location of occupancy, the second set of regions replacing the first set of regions and the second set of regions different than the first set of regions;
assigning the region associated the location of occupancy as a second designated region to the first asset; and
presenting the virtual map representing the second set of regions on a display associated with the facility.

30. The method of claim 29, further comprising:
responsive to generating the second set of regions, reassigning a second asset associated with a second vehicle enroute to the facility to a new region of the second set of regions; and
sending, to a device associated with the second vehicle, an alert associated the new region.
